(19) United States
(12) Patent Application Publication
(10) Pub. No.: US 2009/0178451 A1
(43) Pub. Date: Jul. 16, 2009

(54) Lock core assembly

(76) Inventors: Hsiu-Chuan Wu, Kanding Hsiang (TW); I-Chien Hsin, Banciao City (TW)

Correspondence Address: Joe McKinney Muncy, PO Box 1364, Fairfax, VA, 22038-1364, US

(21) Appl. No.: 12/007,840

(22) Filed: Jan. 16, 2008

(51) Int. Cl. E05B 27/04

(52) U.S. Cl. 70/493

(57) ABSTRACT

A lock core assembly has a lock shell, a lock core and a pin segment. The lock shell has a core mount, multiple upper pin chambers, a lid and at least one retaining flange. The lock core is mounted rotatably in the core mount and has a keyhole and multiple lower pin chambers. The lower pin chambers are formed radially through an outer surface of the lock core, communicate with the keyhole, align longitudinally, correspond to and communicate with the upper pin chambers. The pin segment is mounted between the lock shell and the lock core and has multiple abutting pin assemblies and at least one suspended pin assembly. When knocked, a suspended upper pin of the at least one suspended pin assembly prevents the pin aligning and the lock core from rotating, the lock core assembly provides a preferred burglarproofing effect.

### BACKGROUND OF THE INVENTION

1. Field of the Invention

The present invention relates to a lock core assembly, and more particularly to a lock core assembly that has a suspended structure to provide a preferred burglarproofing effect.

2. Description of Related Art

A conventional lock core assembly has a lock shell, a lock core and multiple pin assemblies. The lock core is mounted rotatably in the lock shell and has a keyhole and an interface. The interface is defined between the lock core and lock shell. The pin assemblies are respectively mounted through the lock shell and in the lock core and each pin assembly has a lower pin, an upper pin and a spring. The lower pins are mounted slidably in the lock core and have various lengths and a top. The upper pins have a bottom, are mounted slidably in the lock shell and the bottoms of the upper pins abut the tops of the lower pins. The springs are mounted between the upper pins and the lock shell to press the upper pins against the lower pins.

Therefore, the upper pin of each pin assembly is disposed at the interface between the lock core and lock shell. To open the lock, a key having multiple corresponding ridges of various lengths is inserted into the keyhole. The multiple ridges correspond in length to the lower pin assemblies and push the lower pin assemblies against the springs causing the bottoms of the upper pins and tops of the lower pins to align with the interface between the lock shell and lock core and allow the lock core to rotate relative to the lock shell.

However, a burglar may try to use a lock pick to vibrate or knock the lock core assembly thereby forming a gap between the upper and lower pins of the pin assemblies. When the gap between the upper and lower pins of the pin assemblies are aligned with the interface between the lock shell and the lock core, the burglar can turn the lock core relative to the lock shell to unlock the lock core assembly. Therefore, the conventional lock core assembly requires improved burglarproofing.

To overcome the shortcomings, the present invention provides a lock core assembly with a suspended structure to mitigate or obviate the aforementioned problems.

### SUMMARY OF THE INVENTION

The primary objective of the present invention is to provide a lock core assembly that has a suspended structure to provide a preferred burglarproofing effect.

The lock core assembly in accordance with the present invention has a lock shell, a lock core and a pin segment. The lock shell has a core mount, multiple upper pin chambers, a lid and at least one retaining flange. The lock core is mounted rotatably in the core mount and has a keyhole and multiple lower pin chambers. The lower pin chambers are formed radially through an outer surface of the lock core, communicate with the keyhole, align longitudinally, correspond to and communicate with the upper pin chambers. The pin segment is mounted between the lock shell and the lock core and has multiple pin assemblies and at least one suspended pin assembly. When knocked, a suspended upper pin of the at least one suspended pin assembly prevents the pin aligning with, and the lock core from rotating; the lock core assembly provides a preferred burglarproofing effect.

Other objectives, advantages and novel features of the invention will become more apparent from the following detailed description when taken in conjunction with the accompanying drawings.

### BRIEF DESCRIPTION OF THE DRAWINGS

FIG. 1 is a side view in partial section of the lock core assembly in accordance with the present invention when the lock core assembly is locked;

FIG. 2 is a front view in partial section of the lock core assembly along line 2-2 in FIG. 1;

FIG. 3 is an operational side view in partial section of the lock core assembly in FIG. 1, shown with a corresponding key inserted into a lock core of the lock core assembly; and

FIG. 4 is a front view in partial section of the lock core assembly along line 4-4 in FIG. 3.

### DETAILED DESCRIPTION OF THE PREFERRED EMBODIMENT

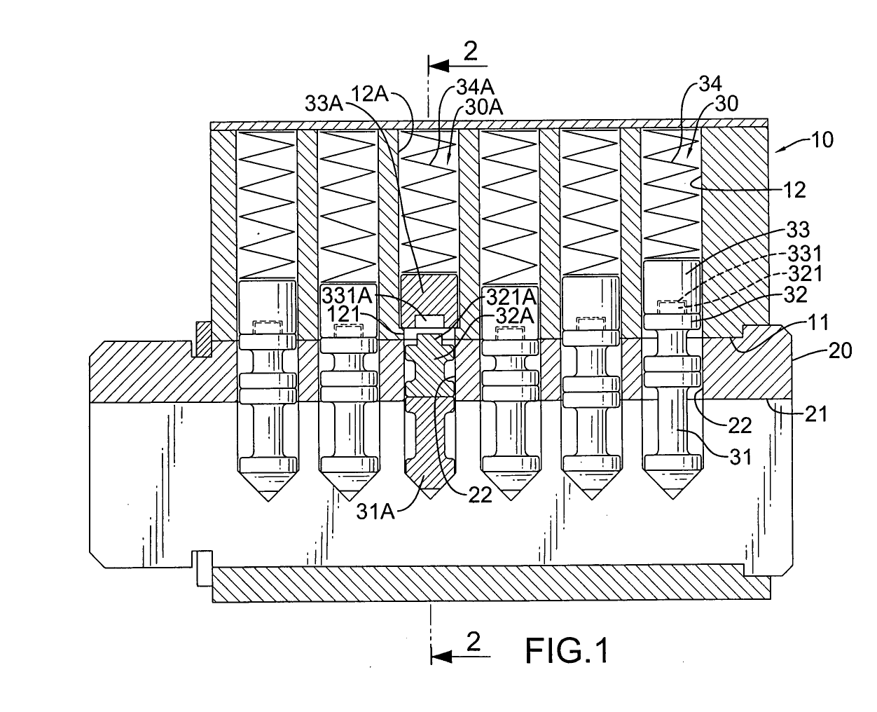

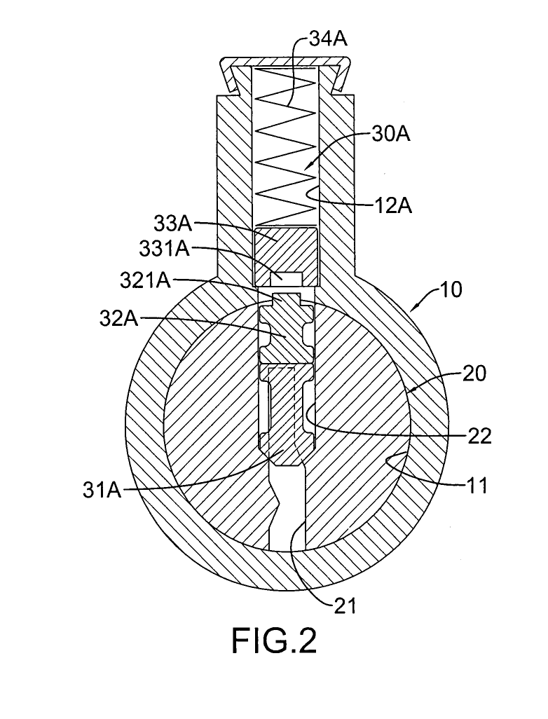

With reference to FIGS. 1 and 2, a lock core assembly in accordance with the present invention has a lock shell (10), a lock core (20) and a pin segment.

The lock shell (10) has an outer surface, a core mount (11), multiple upper pin chambers (12, 12A) and a lid.

The core mount (11) is formed longitudinally through the lock shell (10) and has an inner surface.

The upper pin chambers (12, 12A) include at least one suspended upper pin chamber (12A) and at least one abutting pin chamber (12), are formed radially through the outer surface of the lock shell (10), are aligned longitudinally and communicate with the core mount (11), and each one of the at least one of the suspended upper pin chamber (12A) has a retaining flange (121) formed in the suspended upper pin chamber (12A) near the core mount (11) and is smaller in diameter than the suspended upper pin chamber (12A).

The lid is mounted detachably on the outer surface of the lock shell (10) and covers the upper pin chambers (12, 12A).

The lock core (20) may be a cylinder, is mounted rotatably in the core mount (11) in the lock shell (10) and has an outer surface, an interface, a keyhole (21) and multiple lower pin chambers (22).

The interface is defined between the outer surface of the lock core (20) and the core mount (11).

The keyhole (21) is formed longitudinally in the lock core (20).

The lower pin chambers (22) are formed radially through the outer surface of the lock core (20), communicate with the keyhole (21) and respectively align with, correspond to and communicate with the upper pin chambers (12, 12A).

The pin segment is mounted between the lock shell (10) and the lock core (20) and has a default position, at least one suspended pin assembly (30A) and at least one abutting pin assembly (30).

The at least one suspended pin assembly (30A) is mounted in the at least one suspended upper pin chamber (12A) hand at least one of the lower pin chamber (22) which corresponds to the at least one suspended upper pin chamber (12A) and each one of the at least one suspended pin assembly has a lower pin (31A), a middle pin (32A), a suspended upper pin (33A) and a second spring (34A).

The lower pin (31A) is mounted slidably in a corresponding lower pin chamber (22) and aligns with a corresponding suspended upper pin chamber (12A) and has a top end, a middle and a bottom end. The middle of the lower pin (31A) is smaller in diameter than the ends of the lower pin (31A).

The middle pin (32A) is mounted on the top end of the lower pin (31A) between the lower pin chamber (22) and the a corresponding retaining flange (121) and has a top end, a middle, a bottom end and an optional mounting rod (321A). The bottom end of the middle pin (32A) is mounted on the top end of the lower pin (31A). The middle of the middle pin (32A) is smaller in diameter than the ends of the middle pin (32A). The mounting rod (321A) is formed on and protrudes from the top end of the middle pin (32A).

The suspended upper pin (33A) is mounted slidably in the corresponding suspended upper pin chamber (12A) and stopped on the corresponding retaining flange (121) to form a gap from the middle pin (32A) and has a top end, a bottom end and a mounting recess (331A). The mounting recess (321A) is formed in the bottom of the suspended upper pin (32A) corresponds to and is aligned with the mounting rod (321A) of the middle pin (32A).

Each second spring (34A) is mounted in the corresponding suspended upper pin chamber (12A) between the corresponding retaining flange (121) and the lid, is attached to the top end of the suspended upper pin (33A) and presses the upper pin (33A) against the corresponding retaining flange (121) at a gap from the middle pin (32A) of the suspended pin assembly (30A).

The at least one abutting pin assembly (30) is mounted in the at least one abutting upper pin chamber (12) and the at least one of the lower pin chamber (22) which corresponds to the at least one abutting upper pin chamber (12), and each one of the at least one abutting pin assembly (30) has a lower pin (31), a middle pin (32), an upper pin (33) and a first spring (34).

The lower pins (31) have top ends, various lengths and are respectively mounted slidably in corresponding lower pin chambers (22).

The middle pins (32) are respectively mounted on the tops of the lower pins (31) and each middle pin (32) has a top end, a bottom end and a mounting rod (321). The bottom end of the middle pin (32) is mounted on the top end of the lower pin (31). The mounting rod (321) is formed on the top of the middle pin (32).

The upper pins (33) are mounted slidably in the corresponding abutting upper pin chambers (12), abut the middle pins (32) and each upper pin (33) has a top end, a bottom end and a mounting recess (331). The mounting recess (331) is formed in the bottom end of the upper pin (33) and is mounted securely with the mounting rod (321) of the middle pin (32).

The first springs (34) are mounted respectively in the abutting upper pin chambers (12) between the upper pins (33) and the lid and each first spring (34) presses the upper pin (33) against the middle pin (32) in the default position.

Since the lower pins (31, 31A) do not have uniform lengths, in the default situation, the upper pins (33, 33A) of the pin assemblies (30, 30A) are disposed at the interface between the lock shell (10) and the lock core (20) and prevent the lock core (20) from rotating relative to the lock shell (10).

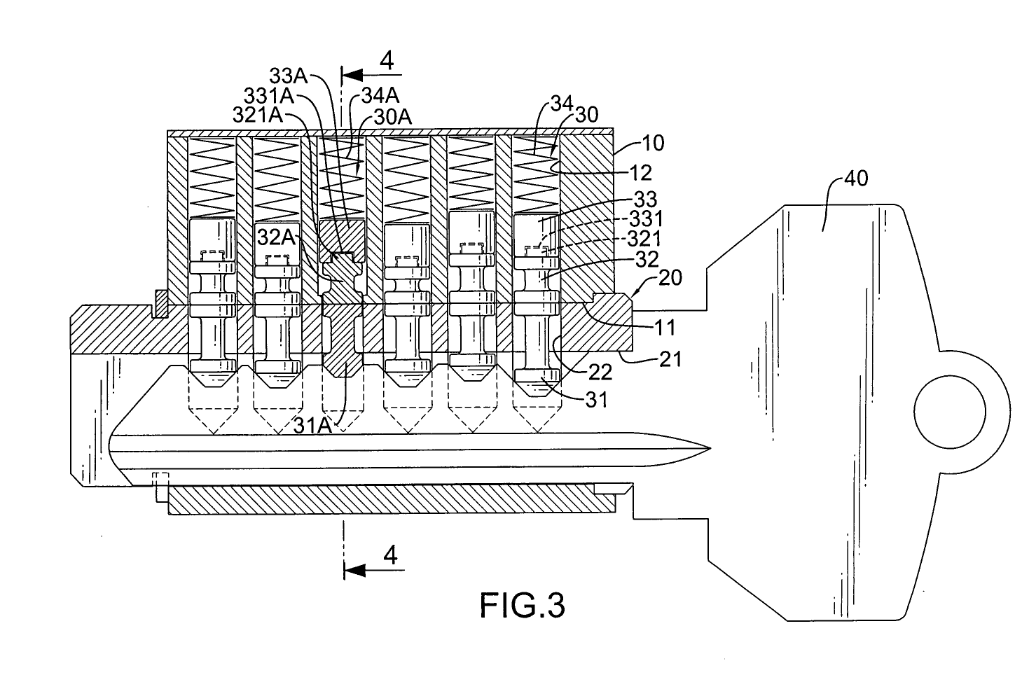

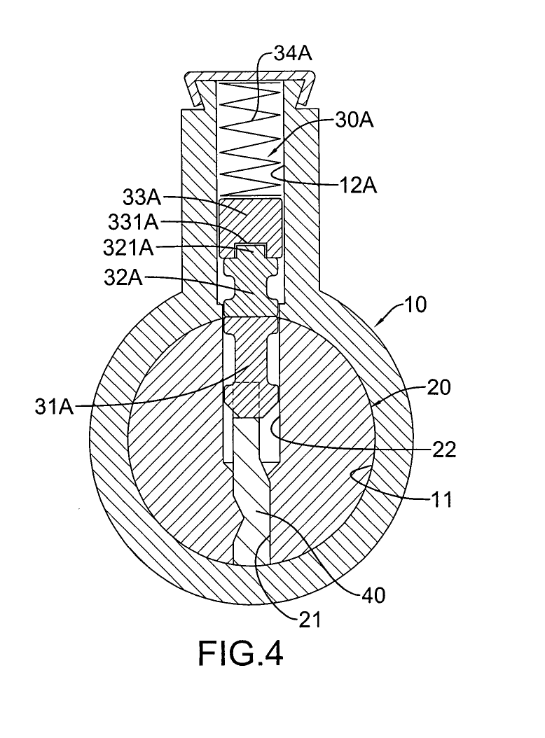

With further reference to FIGS. 3 and 4, when a corresponding key (40) having multiple ridges is inserted into the keyhole (21) in the lock core (20), the ridges on the key (40) abut and press the pin assemblies (30, 30A) up to align the bottoms of the middle pins (32, 32A) and the tops of the lower pins (31, 31A) with the interface between the core mount (11) and the lock core (20), allowing the lock core (20) to turn relative to the lock shell (10) to unlock the lock core assembly.

However, when a lock pick is used to bounce and align the upper, middle and lower pins (33, 33A, 32, 32A, 31, 31A), the suspended upper pin (33A) of the at least one suspended pin assembly (30A) has a gap from the middle pin (32A) by the corresponding retaining flange (121) to prevent the middle pin (32A) from aligning and mounting securely with the suspended upper pin (33A) when a burglar vibrates or knocks the lock core assembly to turn the lock core (20). Therefore, the lock core assembly in accordance with the present invention can provide a preferred burglarproofing effect. Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lock core assembly having
a lock shell having
an outer surface;
a core mount being formed longitudinally through the lock shell and having an inner surface;
multiple upper pin chambers including at least one suspended upper pin chamber and at least one abutting upper pin chamber, being formed radially through the outer surface of the lock shell, being aligned longitudinally and communicating with the core mount, and each one of the at least one of the suspended upper pin chambers having a retaining flange formed in the suspended upper pin chamber near the core mount and being smaller in diameter than the suspended upper pin chamber; and
a lid being mounted detachably on the outer surface of the lock shell and covering the upper pin chambers; and
a lock core being mounted rotatably in the core mount in the lock shell and having
an outer surface; and
an interface being defined between the outer surface of the lock core and the core mount;
a keyhole being formed longitudinally in the lock core; and
multiple lower pin chambers being formed radially through the outer surface of the lock core, communicating with the keyhole and respectively aligning with, corresponding to and communicating with the upper pin chambers; and
a pin segment being mounted between the lock shell and the lock core and having
at least one suspended pin assembly being mounted in the at least one suspended upper pin chamber and at least one of the lower pin chamber which corresponds to the at least one suspended upper pin chamber, and each one of the at least one suspended pin assembly having
a lower pin being mounted slidably in a corresponding lower pin chamber and aligning with a corresponding suspended upper pin chamber and having
a top end;
a middle; and
a bottom;
a middle pin being mounted on the top end of the lower pin between the corresponding lower pin chamber and a corresponding retaining flange and having
a top end;
a middle; and
a bottom end being mounted on the top end of the corresponding lower pin;
a suspended upper pin being mounted slidably in the corresponding suspending upper pin chamber and supported on the corresponding retaining flange to form a gap from the middle pin; and
a second spring being attached to the suspended upper pin and pressing the upper pin against the corresponding retaining flange at the gap from the middle pin of the suspended pin assembly; and
at least one abutting pin assembly being mounted in the at least one abutting upper pin chamber and the at least one of the lower pin chamber which corresponds to the at least one abutting upper pin chamber, and each one of the at least one abutting pin assembly having
a lower pin being mounted slidably in a corresponding lower pin chamber and having a top end;
a middle pin being mounted on the top of the corresponding lower pin and having
a top end; and
a bottom end being mounted on the top end of the lower pin;
an upper pin being mounted slidably in a corresponding abutting upper pin chamber and having
a top end; and
a bottom end being abutted with the top end of the middle pin; and
a first spring being mounted in the corresponding abutting upper pin chamber between the upper pin and the lid and pressing the upper pin against the middle pin.

2. The lock core assembly as claimed in claim 1, wherein
the middle pin of each one of the at least one suspended pin assembly further has a mounting rod being formed on and protruding from the top of the middle pin;
the suspended upper pin of each one of the at least one suspended pin assembly further has
a top end;
a bottom end; and
a mounting recess being formed in the suspended upper pin from the bottom end to the top end, aligning with the mounting rod of the middle pin;
the second spring of each one of the at least one suspended pin assembly being attached to the top end of the suspended upper pin to suspend the upper pin above the middle pin of the suspended pin assembly at a gap;
the middle pin of each one of the abutting pin assemblies further has a mounting rod being formed on the top of the middle pin;
the upper pin of each one of the abutting pin assemblies further has a mounting recess being formed in the bottom end of the upper pin and being mounted securely with the mounting rod of the corresponding middle pin; and
the first spring of each one of the abutting pin assemblies being attached to the top end of the upper pin to press the upper pin against the middle pin in the default position.

3. The lock core assembly as claimed in claim 1, wherein the middle of the middle pin of each one of the at least one suspended pin assembly is smaller in diameter than the ends of the middle pin.

4. The lock core assembly as claimed in claim 1, wherein the middle of the lower pin of each one of the at least one suspended pin assembly is smaller in diameter than the ends of the lower pin.

5. The lock core assembly as claimed in claim 2, wherein the middle of the middle pin of each one of the at least one suspended pin assembly is smaller in diameter than the ends of the middle pin.

6. The lock core assembly as claimed in claim 2, wherein the middle of the lower pin of each one of the at least one suspended pin assembly is smaller in diameter than the ends of the lower pin.

7. The lock core assembly as claimed in claim 3, wherein the middle of the lower pin of each one of the at least one suspended pin assembly is smaller in diameter than the ends of the lower pin.
